(19) United States
(12) Patent Application Publication
(10) Pub. No.: US 2006/0262907 A1
(43) Pub. Date: Nov. 23, 2006

(54) Switching public safety answering points between central offices

(75) Inventors: Yolius Diroo, San Antonio, TX (US); Edward Walter, Boerne, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/132,904

(22) Filed: May 19, 2005

(51) Int. Cl. H04M 11/04

(52) U.S. Cl. 379/45; 379/49

(57) ABSTRACT

In the present invention, one or more switches (100) can be interconnected to one or more Public Safety Answering Points (202, 302). Each switch has a switching element (102) for interconnecting a first PSAP to one among a plurality of central offices (210, 310), a memory (104) for storage, and a processor (106) for controlling operations of the switching element and the memory. The processor is programmed to detect (408) a service interruption between the first PSAP and a first central office, and cause (412) the switching element to switch the first PSAP to a second central office selected among the plurality of central offices.

### FIELD OF THE INVENTION

This invention relates generally to Public Safety Answering Points (PSAPs), and more particularly to switching PSAPs between central offices.

### BACKGROUND OF THE INVENTION

There are thousands of PSAPs (Public Safety Answering Points) across the United States. These agencies are typically county controlled and are responsible for answering calls for emergency assistance for police, fire and ambulance services.

Typically, PSAPs are tied to two or more central offices to provide redundancy protection. That is, when an interruption in telephony services fails at one central office, the PSAP can switch to the other central office to maintain emergency service operations. Presently, PSAPs utilize crude A/B switches to switch between central offices. As PSAP centers grow with more agents to support emergency call traffic, the wiring complexity to interconnect a number of A/B switches becomes unmanageable and dangerous in the event wiring is performed inappropriately, thereby hindering a switch to another central office when an active one fails to provide services.

A need arises therefore to simplify and substantially eliminate the foregoing deficiencies in the prior art.

### SUMMARY OF THE INVENTION

Embodiments in accordance with the invention provide a method and apparatus for maintaining services of a network element.

In a first embodiment of the present invention, one or more switches are coupled to one or more PSAPs (Public Safety Answering Points). Each switch has a switching element for interconnecting a first PSAP to one among a plurality of central offices, a memory for storage, and a processor for controlling operations of the switching element and the memory. The processor is programmed to detect a service interruption between the first PSAP and a first central office, and cause the switching element to switch the first PSAP to a second central office selected among the plurality of central offices.

In a second embodiment of the present invention, a computer-readable storage medium operates in each of one or more switches coupled to one or more PSAPs (Public Safety Answering Points). Each storage medium has computer instructions for detecting a service interruption between a first PSAP and a first central office, and switching the first PSAP to a second central office selected among the plurality of central offices.

In a third embodiment of the present invention, a method is provided in each of one or more switches coupled to one or more PSAPs (Public Safety Answering Points). The method has the steps of detecting a service interruption between a first PSAP and a first central office, and switching the first PSAP to a second central office selected among the plurality of central offices.

### BRIEF DESCRIPTION OF THE DRAWINGS

FIG. 1 is block diagram of a switch according to an embodiment of the present invention;

FIGS. 2-3 are block diagrams of alternate embodiments of the switch operating in a PSAP according to the present invention; and

FIG. 4 depicts a flowchart of a method operating in the switch according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

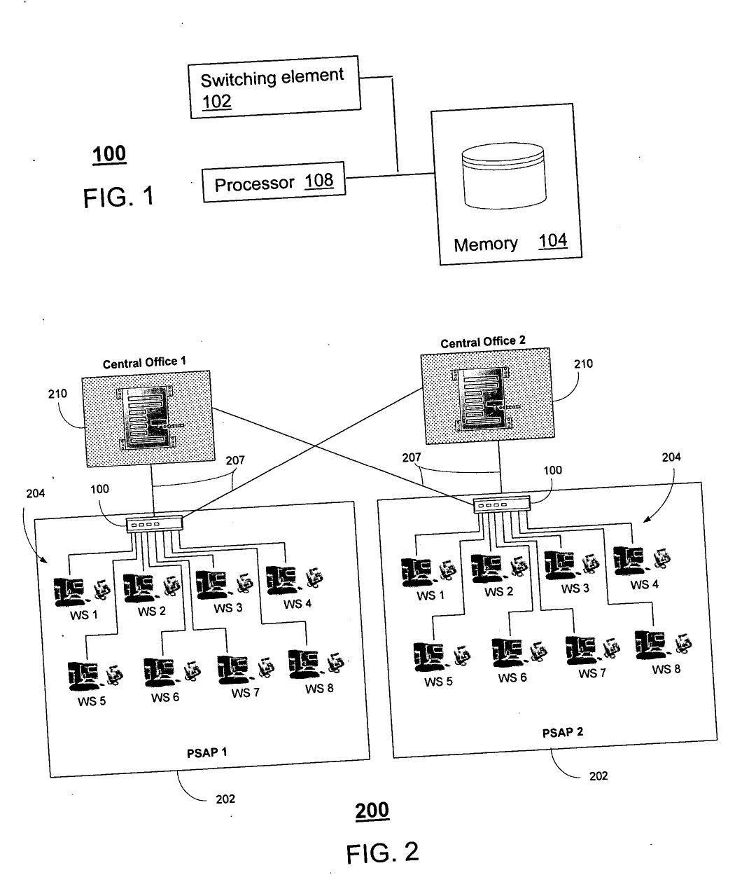

FIG. 1 is block diagram of a switch 100 according to an embodiment of the present invention. The switch 100 comprises a switching element 102, a memory 104 and a processor 108. The switching element 102 can be any conventional switching technology for interconnecting telephony trunks between a central office and one or more workstations of a PSAP as will be described shortly. The telephony trunks can be conventional T1 lines, packet data Internet interfaces such DSL or cable, or any other form of telephony interface presently known and developed in the future.

The memory 104 utilizes conventional media devices (such as a high capacity disk drive) for storage purposes and can be used as a database for managing telephony configuration information as well as PSAP provisioning information as will be described below. The memory 104 can also be used for storing computer instructions for directing the operations of the processor 106 in accordance with the present invention. It will be appreciated that the memory 104 can also use other media storage types such as floppy disks, CD-ROMs, Flash memories, non-volatile ROM, and/or RAM. The processor 108 utilizes conventional technology such as a microprocessor and/or DSP (Digital Signal Processor) for processing telephony information and for managing operations of the switch 100 in accordance with the present invention.

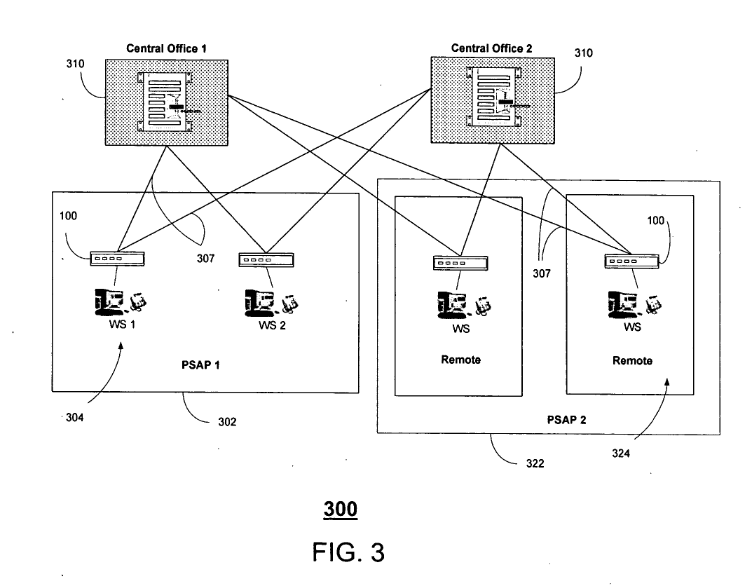

FIGS. 2-3 are block diagrams of alternate embodiments 200, 300 of the switch 100 operating in a PSAP 202 according to the present invention. In FIG. 2, the switch 100 interconnects to two or more central offices 210 with a number of workstations 204 manned by PSAP agents who process emergency calls. The interconnect 207 between the switch 100 and the central offices 210 can be one or more conventional telephony trunks as described earlier.

A central office 210 is a secure, self-contained telecommunications equipment building that houses servers, storage systems, switching equipment, emergency power systems, and related devices that are used to run telephone systems. Although wired interconnects are shown between the switch 100 and the workstations 204, these interconnects can be replaced with conventional wireless interfaces such as IEEE 802.11a/b/g or other like technologies. Additionally, the phones used by agents at the workstations of the PSAP 202 can be analog, digital, and/or utilize packetized technologies such as VoIP (Voice over Internet Protocol).

FIG. 3 depicts an alternate embodiment 300 in which each workstation 304 is interconnected to a switch 100, which in turn is coupled to two or more central offices 310 by way of telephony trunks 307. These interconnects are similar to embodiment 200 with the exception that in the prior embodiment one switch 100 serviced a plurality of workstations 204 at each PSAP 202, while in the present embodiment 300 each workstation 304 has its own switch 100 at each PSAP 302. Each agent can also operate remotely (perhaps at home) thereby forming a virtual PSAP 302. It would be obvious to an artisan with skill in the art that a hybrid of embodiments 200 and 300 can be used in the present invention.

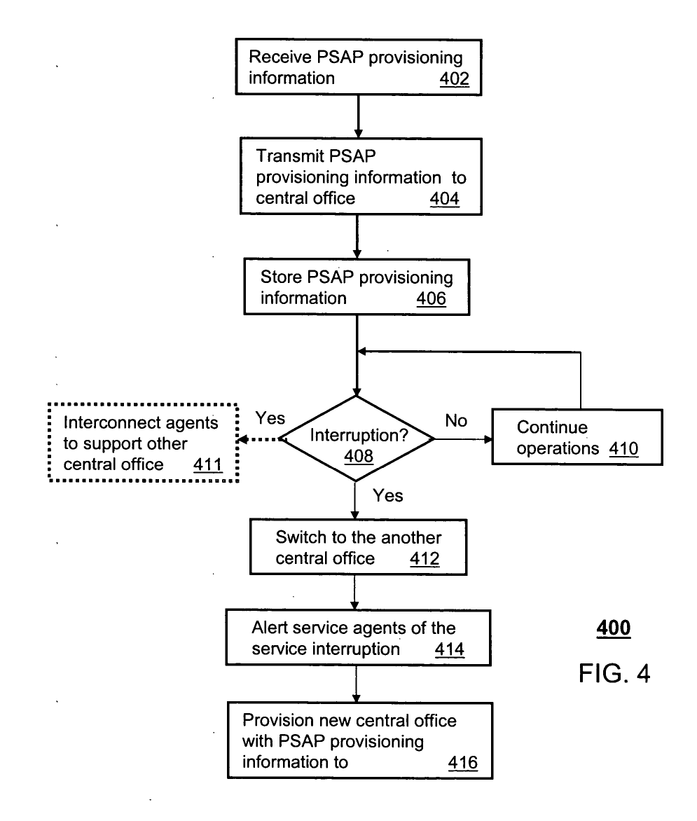

FIG. 4 depicts a flowchart of a method 400 operating in the switch 100 in either of the embodiments 200, 300 of FIGS. 2-3 according to the present invention. Method 400 begins with step 402 where the switch 100 receives PSAP provisioning information from one or more service agents at PSAP 202 (or 302). The provisioning information can be, for example, login information supplied by a service agent to inform the central office 210 or 310 by way of transmission step 404 of her presence and availability to take emergency calls. In step 406, the switch 100 stores the PSAP provisioning information in the memory 104 for service recovery as will be described shortly.

In step 408, each switch 100 checks for a service interruption between the PSAP 202 (or 302) and the central office 210 (or 310) presently serving the PSAP. This function can be performed by means of exchanging keep-alive messages between the central office 210 (310) and the switch 100. A service interruption can be detected in step 408 by, for example, failing to receive an indication from the central office (such as the keep-alive messages) that it is operational, or by the central office 210 (310) informing the switch 100 that service will be interrupted. It will be appreciated by an artisan with skill in the art that any other detectable means for discovering a service interruption is applicable to the invention as claimed herein. If no service interruption is detected, however, then the switch 100 proceeds to step 410 where it continues operations and periodically monitors interruptions in service at step 408.

If, on the other hand, an interruption in service is detected, the switch 100 proceeds to step 412 where it automatically switches the PSAP to another available central office. In embodiment 200, all workstations 204 of a particular PSAP 202 are switched in this step to a new central office 210, while in embodiment 300, each individual workstation 304 is switched by switch 100 to a new central office 310. In step 414 an alert is submitted to one or more agents in the PSAP 202 (or 302) of the switch. The alert can be displayed at a computer of the agent, lights emitted by the phone, or a light and/or audible alarm at switch 100. In step 416, the new central office 210 (or 310) is provisioned with the previous PSAP provisioning information, thereby reducing delay in reestablishing emergency service to a local community served by the PSAP.

In a supplemental embodiment, step 408 can also represent an interruption in service based on a deficiency of agents at one or more PSAPs. In this embodiment a switch 100 of one PSAP 202 can notify in step 408 the switch 100 of the other PSAP 202 of a deficit of one or more agents. This notification can be transmitted between the central office interconnects shown in FIGS. 2 and 3. The deficit can be caused by agents who have called in sick, or due to delegation of agents at the requesting PSAP site to perform other duties. If the same deficit does not exist at the recipient PSAP, the switch 100 can be programmed to interconnect in step 411 available agents to the central office of the requesting PSAP.

This step can be performed independent of agent approval, or after acceptance by one or more agents who are prompted of the request at their respective workstations. Additionally, the interconnect can be unilateral or contemporaneous with previous services. That is, the back up agents can either support emergency calls at the central office of the requesting PSAP only, or support emergency calls from both central offices. In the latter case, the calls can be distributed by the switch 100 evenly so as not to overburden any particular agent.

In yet another embodiment, step 408 can represent an override request supplied by one or more agents at a PSAP. In this embodiment, an agent can request a manual override between central offices for any reason. The override request can be provided by way of a message generated at the workstation or by physically manipulating controls at the switch 100.

In the foregoing embodiments, the switch 100 can also provide any number of telephony services including, but not limited to, caller ID, conferencing of one or more callers, call transfers, and/or fast dial to one or more emergency centers (e.g., police, fire, and rescue, just to name a few). Additionally, the switch 100 can have a scalable design. For example, the switch 100 embodied by the environment depicted in FIG. 2 can have significantly more functionality than the switch 100 depicted in FIG. 3. Varying the design of the switch 100 in this manner provides customers a means to select from a variety of products incorporating the present invention according to customer need.

It should be evident to the reader that the present invention can be realized in hardware, software, or a combination of hardware and software. Thus, the present invention can be embedded in a computer program product, which comprises all the features enabling the implementation of the methods described herein, and which when loaded in the processor 106 is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident that the present invention may be used in many arrangements. Thus, although the description is made for particular arrangements and methods, the intent and concept of the invention is suitable and applicable to other arrangements not described herein. For example, method 400 as described can be reduced to steps 408 and 412 without departing from the claimed invention. It would be clear therefore to those skilled in the art that modifications to the disclosed embodiments described can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. One or more switches coupled to one or more PSAPs (Public Safety Answering Points), each switch comprising:
a switching element for interconnecting a first PSAP to one among a plurality of central offices;
a memory for storage; and
a processor for controlling operations of the switching element and the memory, wherein the processor is programmed to:
detect a service interruption between the first PSAP and a first central office; and
cause the switching element to switch the first PSAP to a second central office selected among the plurality of central offices.

2. The switch of claim 1, wherein the processor is programmed to:
receive PSAP provisioning information from one or more service agents at the first PSAP; and
transmit the provisioning information to the first central office.

3. The switch of claim 2, wherein the processor is programmed to:
store in the memory the PSAP provisioning information of the first central office; and
provision the second central office with the PSAP provisioning information of the first central office after detecting the service interruption.

4. The switch of claim 1, comprising a second PSAP and a second switch coupled to the second PSAP and coupled to one among the plurality of central offices, wherein the processor of the switch coupled to the first PSAP is programmed to:
receive a notification from the second switch of a deficit of one or more agents at the second PSAP; and
interconnect one or more agents of the first PSAP to the central office of the second PSAP to offset the deficit.

5. The switch of claim 1, wherein the processor is programmed to:
receive an indication from the first central office that it is operational; and
detect the service interruption after failing to receive said indication.

6. The switch of claim 1, wherein the processor is programmed to provide one or more telephony services to each agent at the first PSAP, and wherein such services are among one of a group of services comprising caller ID, conferencing of one or more callers, call transfers, and fast dial to one or more emergency centers.

7. The switch of claim 1, wherein the processor is programmed to cause the switching element to switch between central offices according to an override request supplied by the first PSAP.

8. The switch of claim 1, wherein each agent of the one or more PSAPs has a workstation coupled to a switch, and wherein each switch is coupled to the plurality of central offices and operates according to the foregoing steps.

9. A computer-readable storage medium operates in each of one or more switches coupled to one or more PSAPs (Public Safety Answering Points), each storage medium comprising computer instructions for:
detecting a service interruption between a first PSAP and a first central office; and
switching the first PSAP to a second central office selected among the plurality of central offices.

10. The storage medium of claim 9, comprising computer instructions for:
receiving PSAP provisioning information from one or more service agents at the first PSAP; and
transmitting the provisioning information to the first central office.

11. The storage medium of claim 10, comprising computer instructions for:
storing the PSAP provisioning information of the first central office; and
provisioning the second central office with the PSAP provisioning information of the first central office after detecting the service interruption.

12. The storage medium of claim 9, comprising a second PSAP and a second switch coupled to the second PSAP and couple to one among the plurality of central offices, wherein the storage medium of the switch coupled to the first PSAP comprises computer instructions for:
receiving a notification from the second switch of a deficit of one or more agents at the second PSAP; and
interconnecting one or more agents of the first PSAP to the central office of the second PSAP to offset the deficit.

13. The storage medium of claim 9, comprising computer instructions for:
receiving an indication from the first central office that it is operational;
detecting the service interruption after failing to receive said indication; and
alerting one or more of the agents of the first central office of the service interruption.

14. The storage medium of claim 9, comprising computer instructions for providing one or more telephony services to each agent at the first PSAP, and wherein such services are among one of a group of services comprising caller ID, conferencing of one or more callers, call transfers, and fast dial to one or more emergency centers.

15. The storage medium of claim 9, comprising computer instructions for switching between central offices according to an override request supplied by the first PSAP.

16. The storage medium of claim 9, wherein each agent of the one or more PSAPs has a workstation coupled to a switch, and wherein each switch is coupled to the plurality of central offices and operates according to the foregoing computer instructions.

17. A method in each of one or more switches coupled to one or more PSAPs (Public Safety Answering Points), comprising the steps of:
detecting a service interruption between a first PSAP and a first central office; and
switching the first PSAP to a second central office selected among the plurality of central offices.

18. The method of claim 17, comprising a second PSAP and a second switch coupled to the second PSAP and coupled to one among the plurality of central offices, wherein the method operating in the switch coupled to the first PSAP comprises the steps of:
receiving a notification from the second switch of a deficit of one or more agents at the second PSAP; and
interconnecting one or more agents of the first PSAP to the central office of the second PSAP to offset the deficit.

19. The method of claim 17, comprising the step of switching between central offices according to an override request supplied by the first PSAP.

20. The method of claim 17, wherein each agent of the one or more PSAPs has a workstation coupled to a switch, and wherein each switch is coupled to the plurality of central offices and operates according to the foregoing steps.
